(19) United States
(12) Patent Application Publication
(10) Pub. No.: US 2014/0032807 A1
(43) Pub. Date: Jan. 30, 2014

(54) METHOD AND SYSTEM FOR MULTIPLE SERVERS TO SHARE A POSTAL SECURITY DEVICE

(71) Applicant: George T. MONROE, Seymour, CT (US)

(72) Inventor: George T. MONROE, Seymour, CT (US)

(73) Assignee: Pitney Bowes Inc., Stamford, CT (US)

(21) Appl. No.: 13/558,406

(22) Filed: Jul. 26, 2012

(51) Int. Cl. G06F 13/14; G06F 15/16

(52) U.S. Cl. 710/305

(57) ABSTRACT

Systems and methods that allow a PSD to be physically shared by multiple servers such that if a server fails, another server can be utilized as a backup server for the PSD without any manual intervention or moving of the PSD and without risking loss of data from the PSD. A PSD is interfaced by an interface device to a system level bus that allows for multiple initiators. An initiator is any server that can access and issue commands over the system level bus to access the PSD. When one of the servers fails, the functionality of the server can be rolled to a backup server which will be able to access the PSD over the bus.

### FIELD OF THE INVENTION

The invention disclosed herein relates generally to systems and methods for dispensing evidence of postage payment, and more particularly to online postage dispensing systems in which multiple servers can share the same postal security device.

### BACKGROUND OF THE INVENTION

Postage metering systems generate encrypted information that is printed on a mail piece as part of an indicium evidencing postage payment. The encrypted information includes a postage value for the mail piece combined with other postal data that relate to the mail piece and the postage meter printing the indicium. The encrypted information authenticates and protects the integrity of information, including the postage value, imprinted on the mail piece for later verification of postage payment. Since the indicium incorporates the encrypted information relating to the evidencing of postage payment, altering the printed information in an indicium is detectable by standard verification procedures.

The United States Postal Service (“USPS”) has approved personal computer (PC) postage metering systems as part of the USPS Information-Based Indicia Program (“IBIP”). One type of system that supports PC postage metering systems utilizes a postal security device (“PSD”), which is a secure processor-based accounting that dispenses and accounts for postal value stored therein, that is coupled to a server at a data center that is remote from the PC and accessible through the Internet. The PC runs application software or a web browser for requesting postage indicia from the server located at the data center. All functions required for generating an indicium are performed by the PSD coupled to the server, and the results are returned to the PC where the indicium can be printed on a mail piece or label.

Since a PSD can only handle a single transaction at a time, it is necessary to provide multiple PSD's to handle transaction requests from multiple users simultaneously. Thus, a server can have multiple PSD's coupled to it such that each PSD can handle a different transaction simultaneously. When a customer requests a postage indicium, the customer records, including register values that indicate funds available to the customer for printing postage, are sent to a designated PSD for processing of the transaction, and the results returned to the PC being used by the customer.

Having each PSD coupled directly to the server can lead to several issues, however. One major concern is failure of the server, which will result in each of the PSD's that are coupled to the server being rendered inoperable. Typically, redundant servers would be provided such that functionality of one server can be transferred to a backup server in the event of a server failure. When a PSD is coupled to a server, it is unable to be transferred to a backup server in the event of a server failure without having to physically detach the PSD and physically couple it to the backup server. Furthermore, once a PSD has been initialized for a specific customer, it is not possible to transfer the customer account information to a different PSD without possibly losing information and funds in the customer account.

### SUMMARY OF THE INVENTION

The present invention provides a system and method that allows a PSD to be physically shared by multiple servers such that if a server fails, another server can be utilized as a backup server for the PSD without any manual intervention or moving of the PSD and without risking loss of data from the PSD. This is accomplished by using an interface device to interface the PSD to a system level bus that allows for multiple initiators. An initiator is any server that can access and issue commands over the system level bus to access the PSD. One such type of bus that allows for multiple initiators can be, for example, a Small Computer System Interface (SCSI) bus. Adding a SCSI bus interface to a PSD will allow the PSD to be shared by multiple servers. When one of the servers fails, the functionality of the server can be rolled to a backup server which will be able to access the PSD over the SCSI bus.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, by way of example serve to explain the invention in more detail. As shown throughout the drawings, like reference numerals designate like or corresponding parts.

FIG. 1 illustrates in block diagram form a system according to an embodiment of the present invention;

FIG. 2 illustrates in block diagram form an interface device according to an embodiment of the present invention;

FIG. 3 illustrates in flow diagram form the operation of the system of FIG. 1; and

FIG. 4 illustrates in block diagram form a PSD chassis according to an embodiment of the present invention.

### DETAILED DESCRIPTION OF THE PRESENT INVENTION

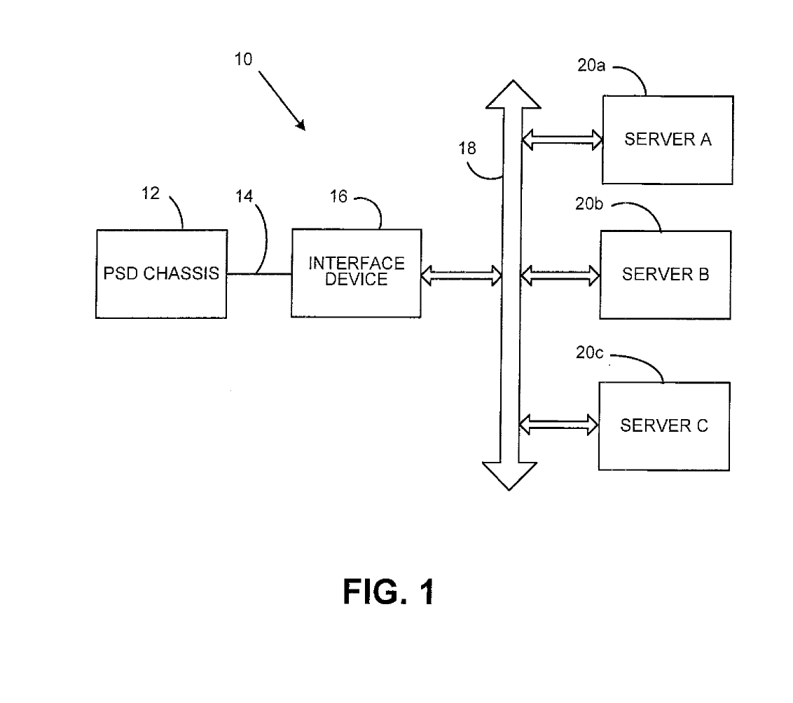

In describing the present invention, reference is made to the drawings, wherein there is seen in FIG. 1 in block diagram form a system 10 according to an embodiment of the present invention. System 10 includes a PSD chassis 12 which holds a plurality of PSD's. The PSD chassis 12 is coupled to an interface device 16 via communication link 14. Interface device 16 is coupled to a system level bus 18. Bus 18 allows for multiple initiators. An initiator is a server that can access and issue commands over the bus 18 to access the PSD chassis 12. Bus 18 could be, for example, a Small Computer System Interface (SCSI) bus. A plurality of servers, e.g., server 20a, 20b, 20c, are also coupled to the bus 18. Each of the servers 20a, 20b, 20c includes one or more processing units for processing data and managing centralized data storage and network communications. While FIG. 1 illustrates three servers, it should be understood that any number of servers can be provided. Each of the servers 20a, 20b, 20c also acts as an initiator as defined above. The interface device 16 allows the PSD chassis 12 to be shared by the servers 20a, 20b, 20c. The servers 20a, 20b, 20c can be accessed via a network (not shown) such as, for example, the Internet, by a user operating a processing device, e.g., personal computer, tablet, or the like.

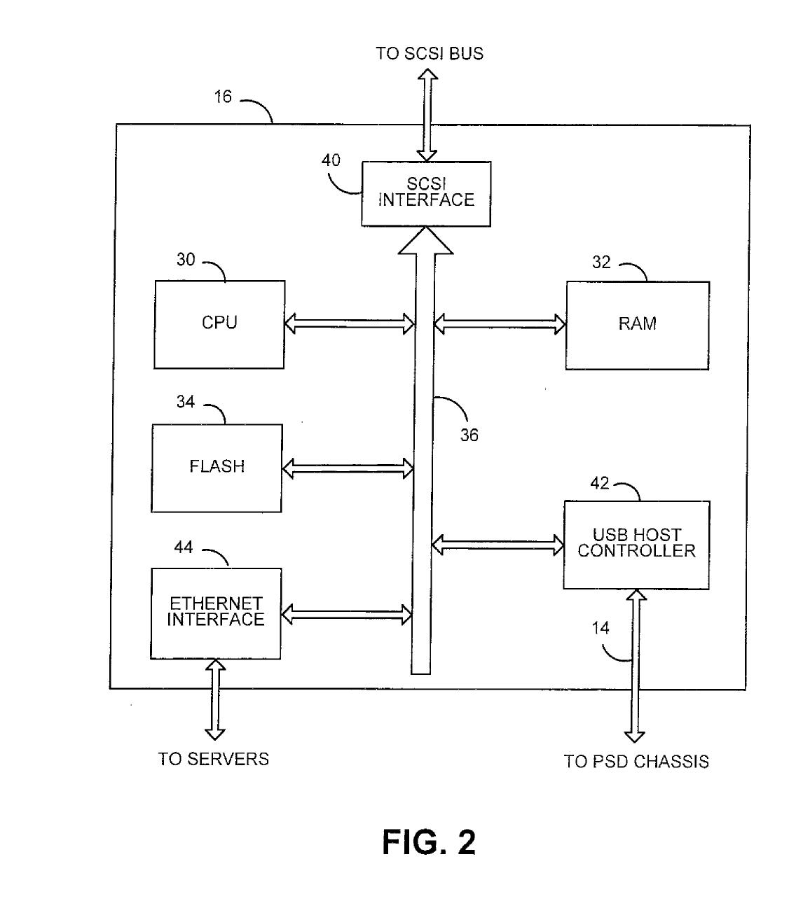

FIG. 2 illustrates in block diagram form an example of an interface device 16 according to an embodiment of the present invention. Interface device 16 includes a central processing unit 30 to control operation of the interface device 16. The CPU 30 can by any type of special or general purpose processing device that utilizes programs and data stored in one or more memories, e.g., RAM 32 and Flash 34, to operate. Each of the CPU 30 and memories 32, 34 communicates via a standard computer bus 36. The bus 36 is coupled to a SCSI interface 40 that allows the interface device 16 to communicate with other devices, e.g., servers 20a, 20b, 20c, via the SCSI bus 18. Optionally, the interface device 16 can include an Ethernet interface controller 44 which can be used in lieu of or in addition to the SCSI interface 40 to allow the interface device 16 to communicate with other devices, e.g., servers 20a, 20b, 20c, via an Ethernet connection. The interface device 16 further includes a USB Host Controller 42 that is coupled to the computer bus 36 and allows for connection to the PSD chassis 12 via communication link 14. The PSD's are preferably USB 1.1 devices, and therefore the communication link 14 is preferably a USB connection.

The CPU 30 executes the requests to USB devices that are coupled to the interface device 16. This involves implementation of the SCSI protocol as well as the protocol used over the ethernet interface 44, such as, for example, iSCSI. The CPU 30 will run an operating system or kernel which will provide TCP/IP network support as well as a USB stack which will provide the required function support needed by USB devices. In addition the operating system or kernel will implement the SCSI protocol which will provide the interface functionality required by the SCSI interface 40.

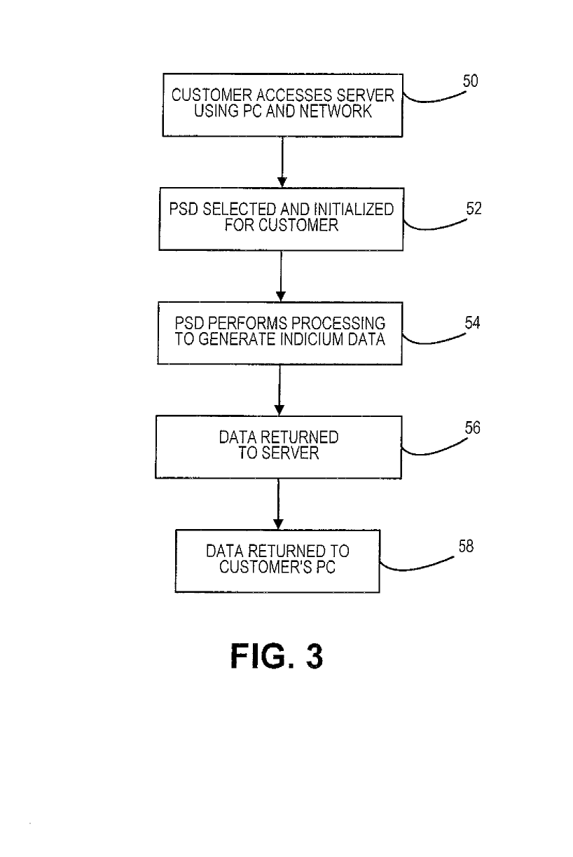

The operation of the system 10 is illustrated in flow diagram form in FIG. 3. In step 50, a user wishing to obtain an indicium that evidences payment of postage utilizes a personal computer or the like connected to a network, e.g., the Internet, to access the server 20a and request the server 20a to dispense the indicium. This can be done, for example using a web browser on the personal computer to access web pages hosted by the server 20a. Upon successful verification of the user and retrieval of the user's account information (stored in a database (not shown) accessed by the server 20a), a PSD from the PSD chassis 12 is selected to perform the necessary operations to generate an indicium and the customer account information is provided to the selected PSD in the PSD chassis 12 via the bus 18, interface device 16, and communication link 14. In step 54 the selected PSD is initialized with the customer account information and the PSD and server 20a perform the processing necessary to generate indicium data. In step 56, the indicium data generated by the PSD is returned to the server 20a (or a back-up server as may be necessary) via the communication link 14, interface device 16, and bus 18. In step 58, the indicium data is processed by the server 20a and then sent from the server 20a to the user's personal computer via the network, e.g. the Internet, where it can be printed on a mail piece or label. Since the interface device 16 allows the PSD chassis 12 to be shared by each of the servers 20a, 20b, 20c, in the event of a failure of the server 20a at any point during the processing described above, the functions of the server 20a can be rolled over to any of the other servers, e.g., server 20b or 20c, without having to move the PSD chassis 12 or any other manual intervention, as the back-up server can access the PSD chassis 12 through the bus 18 and interface device 16. Additionally, because the customer account information does not need to be transferred to a different PSD, there is no risk of losing any data or of the data becoming corrupted during a transfer.

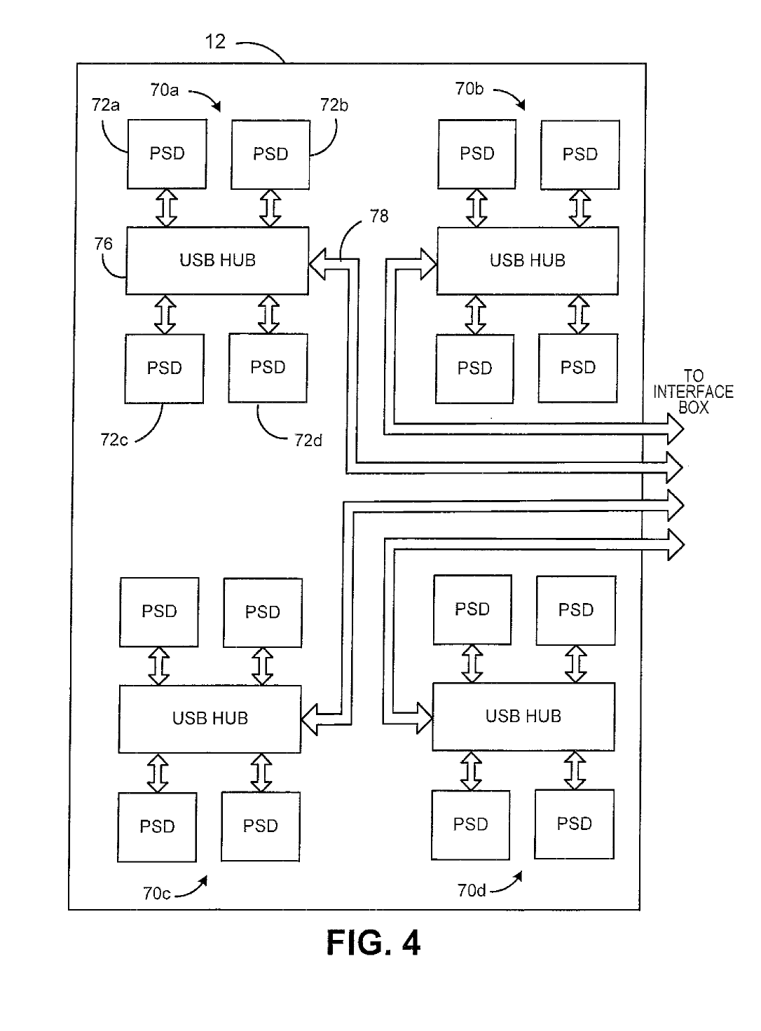

FIG. 4 illustrates in block diagram form an example of a PSD chassis 16 according to an embodiment of the present invention. As illustrated in FIG. 4, PSD chassis 12 includes four groups 70a, 70b, 70c, 70d of PSDs. Each group 70a-70d includes four different PSD's, e.g., as illustrated group 70a includes PSD's 72a, 72b, 72c, 72d. The PSD's 72a-72d are preferably USB 1.1 devices, and therefore can be coupled to a high speed four port USB Hub 76, which in turn is connected to a USB bus 78 for coupling to the interface device 16. The other groups 70b, 70c and 70d are similar to 70a and the description need not be repeated. Thus, the chassis 12 as illustrated in FIG. 4 includes sixteen different PSD's, each of which can be accessed by any one of the servers 20a, 20b, 20c via the interface device 16 and bus 18 without having to manually remove the chassis 12 and reconnect it to the new server and without having to transfer any of the data from one PSD to another. It should be understood that while FIG. 4 illustrates the PSD chassis 12 as containing four groups of four PSD's each, the PSD chassis 12 is not so limited and can be provided with any number of groups and any number of PSD's in each group as desired.

While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A postage dispensing system comprising:
a system level bus;
a plurality of servers coupled to the system level bus, each of the servers acting as an initiator on the system level bus;
an interface device coupled to the system level bus; and
a plurality of postal security devices coupled to the interface device, wherein each of the plurality of postal security devices can be accessed by each of the plurality of servers via the interface device and system level bus.

2. The postage dispensing system of claim 1, wherein the system level bus is a small computer system interface (SCSI) bus.

3. The postage dispensing system of claim 1, wherein the plurality of postal security devices are coupled to the interface device via a USB connection.

4. The postage dispensing system of claim 1, wherein the interface device further comprises:
a processing unit; and
a memory device coupled to the processing unit.

5. The postage dispensing system of claim 4, wherein the interface device further comprises:
an Ethernet interface to provide connection to each of the plurality of servers via an Ethernet.

6. The postage dispensing system of claim 1, wherein the plurality of postal security devices are mounted in a chassis.

7. A method for dispensing postage using a server coupled to a network, the method comprising:
receiving, at the server, a request from a customer for an indicium that evidences payment of postage;
selecting, by the server, one of a plurality of postal security devices to process the request, each of the plurality of postal security devices being coupled to the server via a system level bus and an interface device, the interface device allowing a plurality of servers to access each of the plurality of the postal security devices;
providing customer account information to the selected postal security device;
generating indicium data at the selected postal security device and returning the indicium data to the server; and
returning the indicium data to the customer from the server,
wherein if the server malfunctions, a different server couple to the system level bus can access the selected postal security device to perform processing of the request.

8. The method of claim 7, wherein the system level bus is a small computer system interface (SCSI) bus.

9. The method of claim 7, wherein the plurality of postal security devices are coupled to the interface device via a USB connection.
